(19) United States
(12) Patent Application Publication
(10) Pub. No.: US 2026/0229767 A1
(43) Pub. Date: Aug. 6, 2026

(54) ANTENNA STRUCTURE, DETECTION APPARATUS, AND TERMINAL DEVICE

(71) Applicant: Yinwang Intelligent Technologies Co., Ltd., Shenzhen (CN)

(72) Inventors: Runqiang Jia, Beijing (CN); Xiang Gao, Nanjing (CN); Haowei Li, Shenzhen (CN); Simon TEJERO ALFAGEME, Weilheim (DE); Zhu Sun, Shenzhen (CN); Zhongjie Wu, Shenzhen (CN)

(73) Assignee: Yinwang Intelligent Technologies Co., Ltd., Shenzhen (CN)

(21) Appl. No.: 19/644,406

(22) Filed: Apr. 10, 2026

Related U.S. Application Data
(63) Continuation of application No. PCT/CN2024/123672, filed on Oct. 9, 2024.

(30) Foreign Application Priority Data
Oct. 13, 2023 (CN) 202311333070.4

(51) Int. Cl. H01Q 1/42; H01Q 1/22; H01Q 13/06; H01Q 17/00

(52) U.S. Cl. CPC H01Q 1/42; H01Q 1/22; H01Q 13/065; H01Q 17/00

(57) ABSTRACT

An antenna structure, a detection apparatus, and a terminal device are provided, and relate to the field of millimeter-wave radar technologies, to reduce a profile height of the antenna structure. The antenna structure includes a radome and an antenna, and a first surface of the radome is in contact with a first surface of the antenna. A radiation portion is provided on the first surface of the antenna, a first groove is provided in the first surface of the radome, and the first groove and the radiation portion form a first cavity.

### CROSS-REFERENCE TO RELATED APPLICATIONS

This application is a continuation of International Application No. PCT/CN2024/123672, filed on Oct. 9, 2024, which claims priority to Chinese Patent Application No. 202311333070.4, filed on Oct. 13, 2023. Both of the aforementioned applications are hereby incorporated by reference in their entireties.

### TECHNICAL FIELD

This application relates to the field of millimeter-wave radar technologies, and in particular, to an antenna structure, a detection apparatus, and a terminal device.

### BACKGROUND

In recent years, millimeter-wave radars have been widely used in various fields due to their advantages such as low costs, large bandwidth, high resolution, and strong penetration. For example, in the vehicle-mounted field, a wavelength of a millimeter wave ranges from 1 millimeter to 10 millimeters (mm), and a corresponding frequency range is from 30 gigahertz to 300 gigahertz (GHz). In this frequency band, characteristics related to millimeter waves are highly suitable for vehicle-mounted detection. Therefore, millimeter-wave radars are gradually used in the vehicle-mounted field, and play an increasingly important role.

However, due to limitation of in-vehicle installation space, a specific requirement is imposed on a size of a vehicle-mounted millimeter-wave radar. Currently, however, an overall profile of an antenna structure in a mainstream millimeter-wave radar is high, and consequently, the millimeter-wave radar occupies large space. Such a constraint makes it difficult to install the millimeter-wave radar in confined in-vehicle space.

In conclusion, how to reduce a profile height of the antenna structure is an urgent technical problem to be resolved in the current millimeter-wave radar field.

### SUMMARY

This application provides an antenna structure, a detection apparatus, and a terminal device, to reduce a profile height of the antenna structure.

According to a first aspect, this application provides an antenna structure, including a radome and an antenna. A first surface of the radome is in contact with a first surface of the antenna. A radiation portion is provided on the first surface of the antenna, a first groove is provided in the first surface of the radome, and the first groove and the radiation portion form a first cavity.

In the foregoing example, the radome and the antenna are attached together, and the groove is provided at a position of the radome corresponding to the radiation portion of the antenna. Therefore, an air gap between the existing radome and the antenna can be saved, to reduce a profile height of the antenna structure, so that the antenna structure is applicable to an application scenario with confined installation space, and further, the groove in the radome ensures an air gap between the radiation portion of the antenna and the radome, thereby maintaining radiation performance of the antenna. It can be learned that in the antenna structure, the profile height can be reduced and radiation performance of the antenna is maintained, thereby considering both radiation performance and a miniaturization embodiment of the antenna structure.

In some embodiments, a size of a groove opening of the first groove is greater than or equal to a size of the radiation portion. In this way, the groove opening of the first groove may cover the entire radiation portion, so that an electromagnetic wave radiated by radiation portion can be incident to the first groove without being blocked by a thick wall of the radome.

In some embodiments, the size of the groove opening of the first groove may be based on a divergence angle of the electromagnetic wave radiated by the radiation portion. For example, in a radiation direction of the electromagnetic wave, it may be that the size of the groove opening of the first groove is equal to or slightly greater than a size of an area in which the electromagnetic wave is radiated to the first groove based on an emergent divergence angle, so that the electromagnetic wave radiated by the radiation portion can be completely transmitted to the first groove.

In some embodiments, the radiation portion includes at least one radiation port. In this way, the radiation portion may have a function of radiating an electromagnetic wave.

In some embodiments, the radiation portion further includes a choke groove. In this way, the radiation portion may further have a function of suppressing a surface wave to reduce interference.

In some embodiments, at least two radiation portions are provided on the first surface, and a connection portion between the at least two radiation portions is in contact with the first surface of the radome. In this way, the groove is provided in an area of the radome corresponding to the radiation portion, and another area of the radome retains contact with the first surface of the antenna, so that structural strength of the radome can be maintained while the profile height is reduced.

In some embodiments, the first surface of the antenna further includes a non-radiation portion, and the non-radiation portion is in contact with the first surface of the radome. In some cases, when a first groove is provided for the radiation portion, the non-radiation portion may be understood as portions on two sides of the radiation portion. When at least two first grooves are provided for at least two radiation portions, the non-radiation portion includes a connection portion between the at least two radiation portions, or may further include a portion located on an outer side of a radiation portion at an edge. In this way, the non-radiation portion retains contact with the first surface of the antenna, so that structural strength of the radome can be further improved.

In some embodiments, the radiation portion includes a transmitting radiation portion and a receiving radiation portion. In this way, grooves are provided in areas of the radome corresponding to the transmitting radiation portion and the receiving radiation portion, so that an electromagnetic wave can be radiated or received, thereby enabling transmission and reception of radiation.

In some embodiments, a support portion is disposed in the first cavity. The support portion is connected between the first surface of the antenna and the radome, and is staggered with respective to the radiation portion. In this way, the support portion is disposed at the first groove to support the weak radome, so that structural strength of the radome at the first groove and a protection capability of the radome can be improved.

In an example of the foregoing embodiment, the support portion includes a plurality of protrusions. For example, when the radiation portion includes a plurality of radiation ports, the plurality of protrusions may be arranged to be staggered with respect to the plurality of radiation ports. In this way, electromagnetic waves radiated from the plurality of radiation ports may be separated by using the plurality of protrusions, to reduce interference between the electromagnetic waves radiated from the plurality of radiation ports.

In some embodiments, the plurality of protrusions may be arranged periodically or aperiodically. In some cases, periodic arrangement is used, to suppress transverse propagation of electromagnetic wave energy on an antenna radiation surface, allowing more electromagnetic wave energy to be radiated along a radiation direction.

In an example of the foregoing embodiment, the support portion may be made of a wave-absorbing material. The wave-absorbing material is a type of material that can absorb or greatly reduce electromagnetic wave energy received on a surface of the wave-absorbing material, to reduce electromagnetic wave interference. In this way, the support portion is made by using the wave-absorbing material, so that a surface wave of the antenna can be suppressed to some extent, further reducing electromagnetic wave interference of the current radiation portion on another radiation portion.

Alternatively, in another example of the foregoing embodiment, a material of the support portion is the same as that of a first housing. For example, both the support portion and the first housing are made of a non-wave-absorbing material, or the support portion and the first housing are cast together. The support portion and the first housing are made of the same material, which can simplify fabrication.

In an example of the foregoing embodiment, the support portion and the first housing may be integrally formed, to reduce a fabrication difficulty.

In some embodiments, a thickness of the radome at the first groove may be an integer multiple of kλ₁. k is any real number in [0.3,0.7], and λ₁ is a wavelength of a center frequency of an electromagnetic wave that is radiated by the radiation portion and that is in a dielectric corresponding to the radome. In some cases, to ensure optimal radiation performance, the thickness of the radome at the first groove may be as an optimal thickness of the radome, that is, an integer multiple of 0.5λ₁, which is an integer multiple of half a dielectric wavelength.

In the foregoing embodiment, an integer multiple of 0.3 to 0.7 times a dielectric wavelength is close to the integer multiple of half a dielectric wavelength. A thickness is selected from a thickness range around the optimal thickness as the thickness of the radome at the first groove, so that radiation performance of the antenna can be ensured while the thickness of the radome is reduced, minimizing interference of the radome on an electromagnetic wave radiated by the antenna.

In some embodiments, the antenna structure may further include a monolithic microwave integrated circuit (MMIC). The MMIC is coupled to the antenna, and is configured to: send a frequency-modulated signal to the antenna, or receive an echo signal from the antenna, and perform target detection based on the echo signal. In this way, the target may be detected by using the MMIC and the antenna.

In some embodiments, the antenna structure may further include a printed circuit board (PCB). The PCB is disposed between the antenna and the MMIC, a hole is provided in the PCB, a trace is disposed in the hole, and the MMIC and the antenna are connected by using the trace. In this way, the antenna and the MMIC may be separated by disposing the PCB between the antenna and the MMIC, thereby reducing crosstalk between the antenna and the MMIC.

In some embodiments, the antenna is a waveguide antenna. The waveguide antenna has advantages such as high power, enhanced shielding and low loss.

According to a second aspect, this application provides a detection apparatus, including the antenna structure according to any one of the first aspect and any design in the first aspect.

In some embodiments, the detection apparatus may further include a housing, the housing is connected to the radome to form a cavity, and the antenna is built in the cavity. In this way, the housing and the radome may form a main structure of the detection apparatus, and are configured to prevent an internal antenna from being affected by external environment interference.

According to a third aspect, this application provides a terminal device, including the detection apparatus according to any one of the second aspect and any design in the second aspect.

In some embodiments, the terminal device may further include a skin. The skin is disposed on an outer side of the detection apparatus, and is configured to maintain an aerodynamic profile of the terminal device.

Implementations and beneficial effects of the first aspect to the third aspect are specifically described in the following embodiments.

### BRIEF DESCRIPTION OF DRAWINGS

FIG. 1a is an example of a diagram of an installation manner between a radome and an antenna;

FIG. 1b is an example of a curve diagram of an association relationship between an optimal thickness of a radome and a relative permittivity;

FIG. 1c is an example of a curve diagram of an association relationship between an optimal thickness of a radome and a center frequency of an electromagnetic wave;

FIG. 2 is an example of a diagram of an example application scenario according to this application;

FIG. 3a is an example of a diagram of an antenna structure;

FIG. 3b is an example of a diagram of another antenna structure;

FIG. 4 is an example of a diagram of an antenna structure according to this application;

FIG. 5a is an example of a diagram of a non-radiation portion according to this application;

FIG. 5b is an example of a diagram of another non-radiation portion according to this application;

FIG. 6 is an example of a diagram of an association relationship between a first groove and a divergence angle of an electromagnetic wave according to this application;

FIG. 7 is an example of a diagram of another antenna structure according to this application;

FIG. 8 is an example of a diagram of a structure of a waveguide antenna according to an application scenario 1;

FIG. 9 is an example of a diagram of a structure of a radome for the waveguide antenna in the application scenario 1;

FIG. 10 is an example of a diagram of an antenna structure obtained by assembling the waveguide antenna in the application scenario 1 and the radome;

FIG. 11 is an example of a diagram of a structure of a waveguide antenna according to an application scenario 2;

FIG. 12 is an example of a diagram of a structure of a radome for the waveguide antenna in the application scenario 2;

FIG. 13 is an example of a diagram of an antenna structure obtained by assembling the waveguide antenna in the application scenario 2 and the radome;

FIG. 14 is an example of a diagram of still another antenna structure according to this application;

FIG. 15 is an example of a diagram of a structure of a detection apparatus according to this application;

FIG. 16 is an example of an appearance diagram of a detection apparatus according to this application;

FIG. 17 is an example of a diagram of a structure of a terminal device according to this application; and

FIG. 18 is an example of a comparison diagram of a skin design between a detection apparatus provided in this application and an existing detection apparatus.

### DESCRIPTION OF EMBODIMENTS

The following describes embodiments of this application in detail with reference to the accompanying drawings.

Some terms in this application are described below. It should be noted that these explanations are for ease of understanding by a person skilled in the art, and are not intended to limit the protection scope claimed by this application.

### 1. Radome

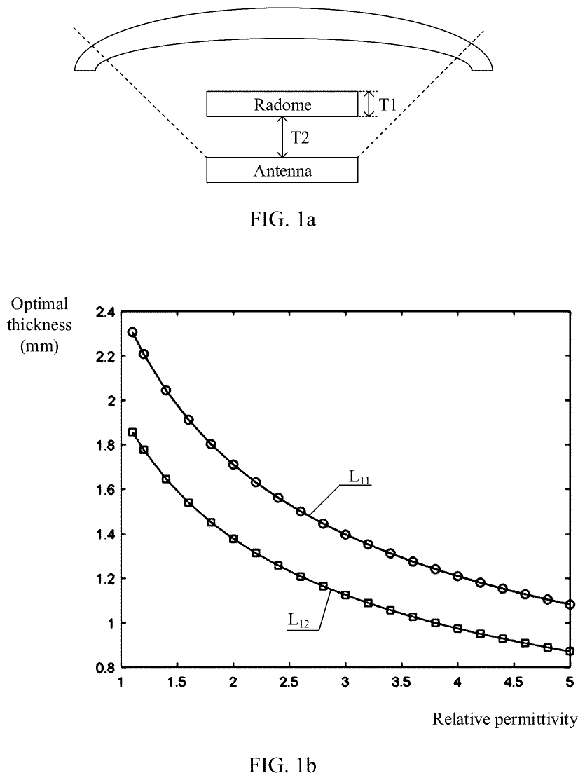

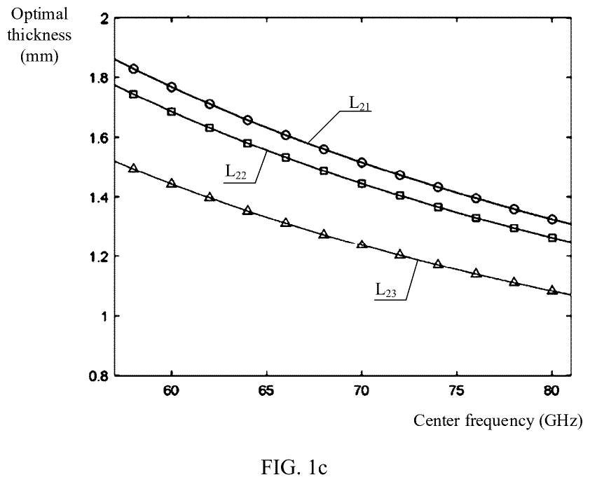

The radome is a functional composite material housing that integrates electromagnetic wave transparency and structural protection, and is usually disposed on an outer side of an antenna. There is an air gap between the radome and the antenna, as shown in FIG. 1a. The radome may provide a structural weatherproof housing to protect the internal antenna and another electronic component from an external adverse environment.

### 2. Relationship Between Antenna Performance and Thickness of a Radome

A structure design of the radome needs to ensure operating performance of the antenna to a greatest extent. The operating performance of the antenna is also referred to as antenna performance or radiation performance of the antenna, and may be understood as a capability of the antenna to receive and transmit an electromagnetic wave in a specific direction. For a normal incident electromagnetic wave, the antenna performance mainly depends on an operating frequency band of the electromagnetic wave, the thickness of the radome (T1 shown in FIG. 1a), a relative permittivity of the radome, an incident angle of the electromagnetic wave, and a shape of the radome. It is found through experiments that, to enable an electromagnetic wave to pass through a radome with a minimal loss, an optimal thickness of the radome should be set to an integer multiple of a dielectric half-wavelength corresponding to a center frequency (which may be understood as a frequency at a center of an operating frequency band of the electromagnetic wave). For details, refer to the following Formula (1.1):

$$T {1}_{best} = \frac{n {λ}_{1}}{2} \qquad ( 1.1 )$$

T1_{best} is the optimal thickness of the radome, and n is a positive integer (to ensure that the radome has specific structural strength, a value of n is usually an integer greater than or equal to 2). λ₁ is a wavelength of the center frequency of the electromagnetic wave in a dielectric corresponding to the radome, which is referred to as a dielectric wavelength of the electromagnetic wave for short, and satisfies the following Formula (1.2):

$${λ}_{1} = \frac{c}{f \times \sqrt{ε}} \qquad ( 1.2 )$$

c is a light speed, ε is a relative permittivity of the dielectric corresponding to the radome, and f is the center frequency.

Further, it can be deduced from the foregoing Formula (1.1) and Formula (1.2) that the relationship between the optimal thickness T1_{best} of the radome, the relative permittivity ε, and the center frequency f satisfies the following Formula (1.3):

$$T {1}_{best} = \frac{nc}{2 f \times \sqrt{ε}} \qquad ( 1.3 )$$

The correspondence shown in the foregoing Formula (1.3) is converted into a graph.

FIG. 1b is a curve diagram of an association relationship between an optimal thickness of a radome and a relative permittivity. A curve L₁₁ and a curve L₁₂ respectively represent curves of an association relationship between an optimal thickness of a radome and a relative permittivity for incident electromagnetic waves with center frequencies of 62 GHz and 77 GHz. Refer to any one of the curve L₁₁ and the curve L₁₂. It can be learned that, when the center frequency of the incident electromagnetic wave is fixed, the optimal thickness of the radome decreases with an increase of the relative permittivity. In other words, if the radome is made of a dielectric material with a small relative permittivity, the optimal thickness of the radome is large, that is, the radome may be made a little thicker. If the radome is made of a dielectric material with a large relative permittivity, the optimal thickness of the radome is small, that is, the radome may be made a little thinner.

FIG. 1c is a curve diagram of an association relationship between an optimal thickness of a radome and a center frequency of an electromagnetic wave. A curve L₂₁, a curve L₂₂, and a curve L₂₃ respectively represent curves of association relationships between center frequencies of electromagnetic waves and optimal thicknesses of radomes made of dielectric materials with relative permittivities of 2.0, 2.2, and 3.0. Refer to any one of the curve L₂₁, the curve L₂₂, and the curve L₂₃. It can be learned that, when the radome is made of a dielectric material (e.g., a same dielectric material) with a same relative permittivity, the optimal thickness of the radome decreases with an increase of a center frequency of an incident electromagnetic wave. In other words, if the center frequency of the incident electromagnetic wave is larger, the optimal thickness of the radome is smaller, that is, the radome may be made a little thinner. If the center frequency of the incident electromagnetic wave is smaller, the optimal thickness of the radome is larger, that is, the radome may be made a little thicker.

### 3. Relationship Between Antenna Performance and a Thickness of an Air Gap

Similar to the optimal thickness of the radome, an optimal thickness of the air gap is an integer multiple of a free-space half-wavelength corresponding to a center frequency (which may be understood as a frequency at a center of an operating frequency band of an electromagnetic wave). For details, refer to the following Formula (2.1):

$$T {2}_{best} = \frac{m {λ}_{2}}{2} \qquad ( 2.1 )$$

T2_{best} is the optimal thickness of the radome, m is a positive integer, and λ₂ is a wavelength of the center frequency of the electromagnetic wave in free space.

The foregoing describes some terms used in this application, and the following describes example application scenarios of this application.

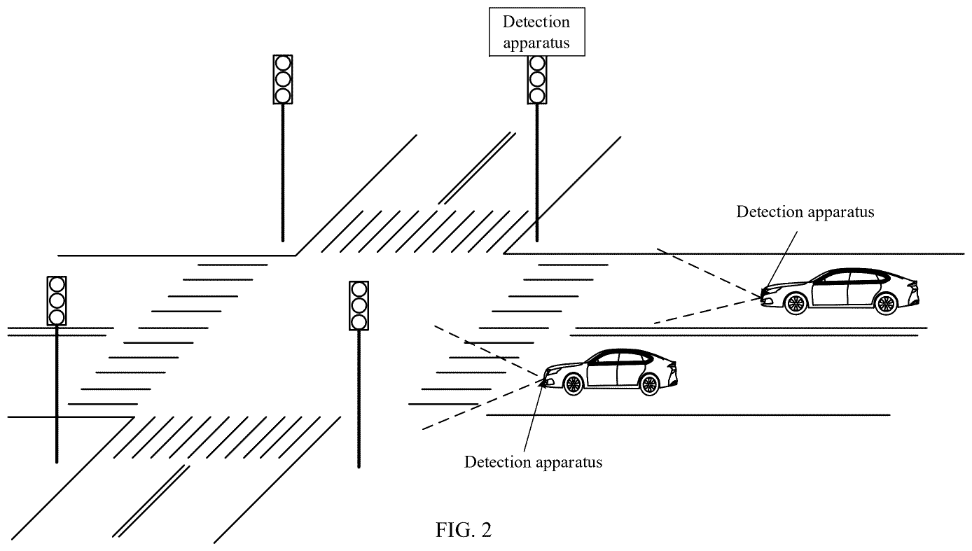

In an embodiment, the antenna structure may be integrated into a detection apparatus, and the detection apparatus may be installed on a vehicle. The detection apparatus may be, for example, a millimeter-wave radar. FIG. 2 is an example of a diagram of an example application scenario according to this application. In this application scenario, an example in which a detection apparatus is installed at a front bumper of a vehicle is used. However, it should be understood that the detection apparatus may alternatively be installed in any one or more directions of six directions of the vehicle: the front, rear, left, right, top, and bottom, for example, installed around a vehicle light, around a rear-view mirror, near a vehicle door, at a rear bumper of the vehicle, behind a windshield, or on a roof of the vehicle, to capture environmental information around the vehicle. When the detection apparatus is installed behind the windshield, the detection apparatus has a low requirement on a risk of no gravel collision, and does not affect an appearance of the vehicle. In addition, a front windshield has a window heating and defogging function and a wiper cleaning function.

A millimeter-wave radar is used as an example. An operating principle of the detection apparatus is as follows: The detection apparatus transmits a millimeter wave to a detection area by using a transmit antenna. If a target exists in the detection area, the target may reflect the received millimeter wave back to the detection apparatus (the reflected millimeter wave may be referred to as an echo signal). Then, the detection apparatus receives the echo signal by using a receive antenna, and determines association information of the target after processing the echo signal. For example, the detection apparatus may obtain physical environment information (e.g., a relative distance, a relative speed, an angle, and a moving direction between the vehicle and another object) around a vehicle body of the vehicle in real time or periodically, and then perform target tracking, and recognition and classification based on the detected physical environment information, to perform data fusion with reference to dynamic information of the vehicle body. After a proper decision is made, a driver is notified or warned in various manners, such as sound, light, and tactile sense, or the vehicle is actively intervened in time, to ensure safety and comfort of a driving process, and reduce an accident occurrence probability. Currently, the vehicle can implement advanced driver-assistance system (ADAS) functions such as adaptive cruise control, forward collision warning, blind spot detection, parking aid, and lane change assistant by using a millimeter-wave radar, so that assisted driving or autonomous driving of the vehicle can be implemented.

It should be understood that the foregoing application scenario is merely an example. The antenna structure provided in this application may be further used in another example scenario, which is not limited to the scenario shown in the foregoing example. For example, the antenna structure may alternatively be installed on a roadside traffic radar, and is configured to: perform violation detection on a vehicle passing through a surrounding road, or monitor a congestion degree of a current traffic environment, and perform evacuation in a timely manner, or communicate with the vehicle, to implement intelligent vehicle-road cooperative communication and the like. For another example, the detection apparatus integrated with the antenna structure provided in this application may alternatively be installed on an airplane, for example, an uncrewed aerial vehicle, a passenger aircraft, a forest protection aircraft, or an aerial survey craft, to monitor an obstacle in a flight environment and avoid the obstacle in a timely manner, thereby reducing accidents. For another example, the detection apparatus integrated with the antenna structure provided in this application may alternatively be installed on a ship, and is used as a shipborne detection apparatus to assist the ship in safe driving. For another example, the antenna structure provided in this application may alternatively be used in a terminal device, or may be disposed in a component of the terminal device. The terminal device may be, for example, a smart home device, an intelligent manufacturing device, a robot, or an intelligent transportation device. The intelligent transportation device may be, for example, an automated guided vehicle (AGV) or an unmanned transport vehicle. Details are not listed herein one by one.

It should be noted that the application scenarios described in this application are intended to describe the technical solutions in this application more clearly, and do not constitute a limitation on the technical solutions provided in this application. For example, the foregoing application scenarios may be used in fields such as uncrewed driving, autonomous driving, assisted driving, intelligent driving, networked vehicles, security surveillance, biomedical care, or surveying and mapping (e.g., three-dimensional drawing).

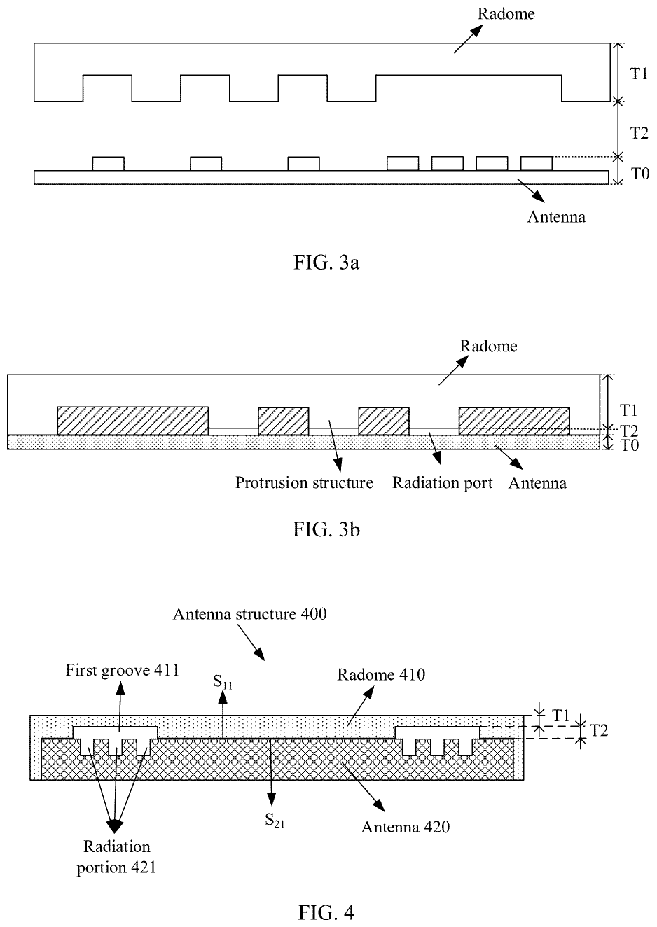

As described in the Background, the overall profile of the antenna structure in the existing millimeter-wave radar is high. This is mainly because an air gap is set between a radome and an antenna in the existing millimeter-wave radar, as shown in FIG. 3a. Therefore, a height of the entire antenna structure is at least a sum of a thickness TO of the antenna, a thickness T2 of the air gap, and a thickness T1 of the radome. Based on the analysis of the foregoing term explanations, to reduce interference of the radome and the air gap to an electromagnetic wave radiated by the antenna, the thickness T1 of the radome is usually set to an optimal thickness T1_{best} of the radome, that is, an integer multiple of half of a dielectric wavelength of the radome, and the thickness T2 of the air gap is usually set to an optimal thickness T2_{best} of the air gap, that is, an integer multiple of half of a free-space wavelength. Such a constraint is applicable to a printed circuit board (PCB) antenna, but is extremely difficult for a waveguide antenna. Because a profile height TO of the waveguide antenna is much higher than that of the PCB antenna, a higher waveguide antenna plus two additional thicknesses T1 and T2 makes an overall profile height of an antenna structure very high, and further makes it more difficult to install a millimeter-wave radar having the waveguide antenna. Especially in the vehicle-mounted field, it is difficult to encapsulate such a high millimeter-wave radar into confined installation space (such as the space inside a bumper).

For the problem of the excessively high profile of the antenna structure, although currently a height of an antenna structure may be reduced in some millimeter-wave radars, as shown in FIG. 3b, in the millimeter-wave radar, a protrusion structure is actually disposed right above a radiation port, to change a width of a beam radiated from the radiation port by adjusting a thickness of the protrusion structure, thereby obtaining a large-bandwidth antenna. However, due to existence of the protrusion structure, a thickness of an air gap between a radome and an antenna is also correspondingly reduced and a thickness of the radome is increased, so that the thickness T2 of the air gap is less than an optimal thickness T2_{best} of the air gap, and the thickness T1 of the radome is greater than an optimal thickness T1_{best} of the radome, affecting radiation performance of the antenna. In other words, the millimeter-wave radar actually improves the beam width at the cost of antenna performance. Although this can potentially reduce the height of the antenna structure, the antenna performance cannot be ensured while the height of the antenna structure is reduced.

In view of this, this application provides an antenna structure. In the antenna structure, a radome and an antenna are attached together, and a groove is provided at a position of the radome corresponding to a radiation portion of the antenna. This is equivalent to moving the air gap (e.g., T2 shown in FIG. 3a) between the radome and the antenna in the existing antenna structure to the inside of the radome for example, to remove the air gap between the radome and the antenna, thereby effectively reducing a profile height of the antenna structure. In addition, the groove in the radome ensures an air gap between the radiation portion of the antenna and the radome. This maintains radiation performance of the antenna, thereby reducing the profile height of the antenna structure and ensuring antenna performance.

Based on the foregoing content, the following describes in detail the solutions provided in embodiments of this application with reference to FIG. 4 to FIG. 18.

In embodiments of this application, unless otherwise stated or there is a logic conflict, terms and/or descriptions between different embodiments are consistent and may be mutually referenced, and technical features in different embodiments may be combined into a new embodiment based on an internal logical relationship thereof.

In this application, a “distance” does not mean an absolute distance, and a specific engineering error may be allowed. A “thickness” does not mean an absolute thickness, and a specific engineering error may be allowed. “Deep” does not mean an absolute depth, and a specific engineering error may be allowed. A “shape” does not mean an absolutely uniform shape, and a specific engineering error may be allowed.

FIG. 4 is a diagram of an antenna structure according to this application. The antenna structure 400 includes a radome 410 and an antenna 420. A first surface (S₁₁ shown in the figure) of the radome 410 is in contact with a first surface (S₂₁ shown in the figure) of the antenna 420. The first surface S₂₁ of the antenna 420 is provided with a radiation portion 421. The first surface S₁₁ of the radome 410 is provided with a first groove 411. The first groove 411 and the radiation portion 421 form a first cavity.

For example, the radiation portion 421 may be understood as a portion having an electromagnetic wave radiation function. For example, the radiation portion 421 may include at least one radiation port, and the at least one radiation port may be configured to: radiate an electromagnetic wave to the outside of the antenna 420, and/or receive an electromagnetic wave from the outside of the antenna 420. In FIG. 4, an example in which the radiation portion 421 includes a plurality of radiation ports is used. However, it should be understood that in an actual antenna structure 400, a radiation portion 421 may include any quantity of radiation ports, for example, may include one radiation port, or may include two or more radiation ports. For example, in some scenarios, one first groove 411 may be provided for each radiation port in the antenna 420. For another example, in some other scenarios, one first groove 411 may alternatively be provided for all radiation ports in the antenna 420. For another example, in other scenarios, one first groove 411 may alternatively be provided for radiation ports that are clustered together in the antenna 420. Another example is not described. A position of the radome corresponding to the radiation port is included in a range of the first groove, so that an electromagnetic wave radiated from the radiation port can be transmitted to an air layer at the first groove, thereby meeting a requirement of antenna radiation for an air gap, and maintaining radiation performance of the antenna.

Further, for example, the radiation portion 421 may include a transmitting radiation portion and/or a receiving radiation portion. The transmitting radiation portion may be understood as a portion configured to implement an electromagnetic wave transmitting function, for example, may include at least one radiation port configured to transmit an electromagnetic wave. The receiving radiation portion may be understood as a portion configured to implement an electromagnetic wave receiving function, for example, may include at least one radiation port configured to receive an electromagnetic wave. In some cases, in some scenarios, one first groove may be separately provided for the transmitting radiation portion and the receiving radiation portion in the antenna, to separately manage the transmitting radiation portion and the receiving radiation portion. Alternatively, in some other scenarios, one first groove may alternatively be provided for both the transmitting radiation portion and the receiving radiation portion in the antenna, to reduce a difficulty of groove fabrication. Alternatively, in other scenarios, one first groove may alternatively be provided for some radiation ports in the transmitting radiation portion and some radiation ports in the receiving radiation portion of the antenna. Another example is not described.

Further, for example, the radiation portion 421 may have another function in addition to the electromagnetic wave radiation function. For example, in an example, the radiation portion 421 may further include a choke groove. The choke groove is a groove provided in a surface of the antenna, and is configured to suppress an electromagnetic wave on the surface of the antenna (referred to as a surface wave), so as to reduce interference of the surface wave on electromagnetic wave radiation. For details, refer to the following description in an application scenario 2. A position of the radome corresponding to the choke groove is also included in the range of the first groove, so that a gap can be reserved between the choke groove and the radome, to avoid direct contact between the choke groove and the radome, which affects a function of suppressing the surface wave by the choke groove.

For example, in addition to the radiation portion 421, the first surface S₂₁ of the antenna 420 may further include a non-radiation portion. That the first surface S₁₁ of the radome 410 is in contact with the first surface S₂₁ of the antenna 420 may be understood as that the non-radiation portion on the first surface S₂₁ of the antenna 420 is in contact with the first surface S₁₁ of the radome 410. When the radome 410 is provided with one first groove 411 or a plurality of first grooves 411, positions of the non-radiation portion in the antenna 420 vary accordingly, which may specifically meet the following case 1 or case 2:

Case 1: Refer to FIG. 5a. When the first groove 411 is provided in the radome 410, a non-radiation portion 422 may be portions that are on the first surface S₂₁ of the antenna 420 and that are located on two sides of the radiation portion 421, for example, portions circled by two elliptical areas shown in FIG. 5a.

Case 2: When at least two first grooves are provided in the radome 410 and respectively correspond to at least two radiation portions on the antenna 420, a non-radiation portion includes a connection portion between the at least two radiation portions, or may further include a portion located on an outer side of a radiation portion at an edge. For example, refer to FIG. 5b. It is assumed that a transmitting radiation portion 421a and a receiving radiation portion 421b are provided in the first surface S₂₁ of the antenna 420, a first groove 411a is provided at a position of the first surface S₁₁ of the radome 410 corresponding to the transmitting radiation portion 421a, and a first groove 411b is provided at a position of the first surface S₁₁ of the radome 410 corresponding to the receiving radiation portion 421b. In this case, a connection portion (e.g., a portion circled by a middle ellipse) between the transmitting radiation portion 421a and the receiving radiation portion 421b is in contact with the first surface S₁₁ of the radome 410. In some cases, a portion located on an outer side of the transmitting radiation portion 421a (e.g., a portion circled by a left ellipse) and a portion located on an outer side of the receiving radiation portion 421b (e.g., a portion circled by a right ellipse) may also be in contact with the first surface S₁₁ of the radome 410.

In the foregoing example, the groove is provided in an area of the radome corresponding to the radiation portion, and another area of the radome retains contact with the first surface of the antenna, so that structural strength of the radome can be maintained while a profile height is reduced.

For example, still refer to FIG. 4. A size of a groove opening of the first groove 411 may be greater than or equal to a size of the radiation portion 421. For example, in a radiation direction of an electromagnetic wave, the groove opening of the first groove 411 may cover the entire radiation portion 421, so that the electromagnetic wave radiated by the radiation portion 421 is incident to the first groove 411, and then may be emitted through a thin wall of the radome 410, thereby avoiding blockage by a thick wall of the radome 410.

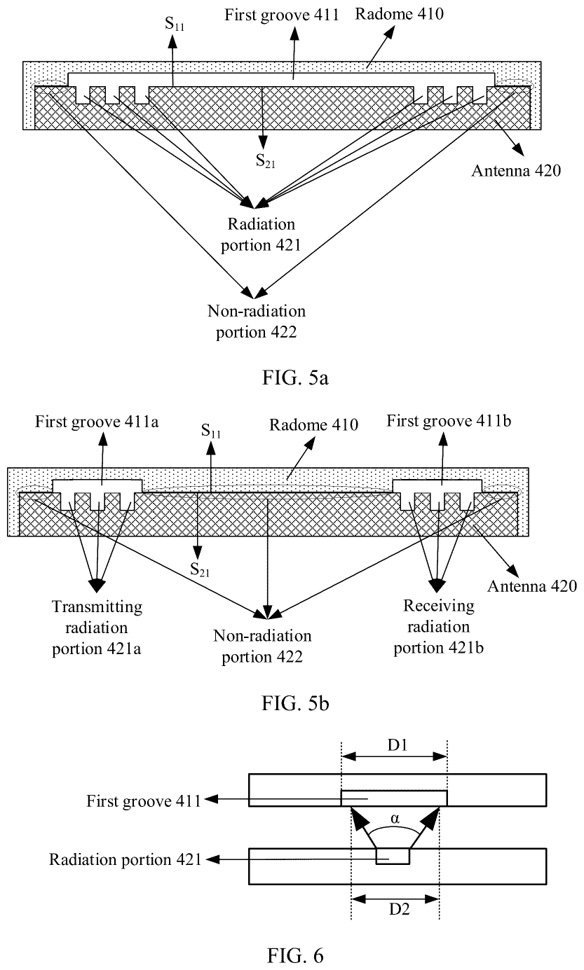

For example, still refer to FIG. 4. The size of the groove opening of the first groove 411 may be based on a divergence angle of an electromagnetic wave radiated by the radiation portion 421. A larger divergence angle of the electromagnetic wave indicates a larger size of the groove opening of the first groove 411. A smaller divergence angle of the electromagnetic wave indicates a smaller size of the groove opening of the first groove 411. In some cases, in a radiation direction of an electromagnetic wave, the size of the groove opening of the first groove 411 is greater than or equal to a size of an area in which the electromagnetic wave is radiated to the first groove 411 based on an emergent divergence angle. For example, a radiation direction is directly facing the radome 410. Refer to FIG. 6. It is assumed that the first groove 411 is a cylindrical groove, a diameter D1 of the first groove 411 may be slightly greater than a diameter D2 of an area that is of the first groove 411 and in which an electromagnetic wave is radiated to the first groove 411 based on an emergent divergence angle α. In this way, the electromagnetic wave radiated by the radiation portion 421 can be transmitted to the first groove 411, to avoid blockage by a thick wall of the radome 410, and a size of the first groove 411 can be reduced, thereby maintaining structural strength of the radome 410.

It should be noted that a shape of the first groove 411 is not limited in this application, provided that the first groove 411 can cover the radiation portion in an actual application scenario in the radiation direction. For example, the first groove 411 may be a regular groove such as a rectangular groove, a square groove, an elliptical groove, a circular groove, or annular groove, or may be an irregular groove such as a splicing groove or a specially-shaped groove.

In addition, in consideration of an impact of process errors such as a manufacturing error and an installation error, the first surface S₁₁ of the radome 410 and the first surface S₂₁ of the antenna 420 may not be strictly zero-spaced, or a small spacing may exist between the first surface S₁₁ of the radome 410 and the first surface S₂₁ of the antenna 420. In an actual antenna structure 400, a gap may alternatively be reserved between the first surface S₁₁ of the radome 410 and the first surface S₂₁ of the antenna 420. The gap may be determined according to a process capability, for example, may be set to 0.4 times a free-space wavelength. In this way, even if a thickness of the radome 410 at the first surface S₁₁ is greater than an ideal thickness due to the impact of the manufacturing error, or a thickness of the antenna 420 at a position corresponding to the first surface S₂₁ is greater than an ideal thickness, the radome 410 and the antenna 420 can be installed together by using the reserved gap.

The components in FIG. 4 are described below to provide an example solution.

### 1. Antenna

In some cases, the antenna 420 may be a transceiver-integrated antenna, or may be a transmit/receive-separated antenna. When the antenna is a transceiver-integrated antenna, any radiation portion 421 on the antenna 420 may be configured to: transmit an electromagnetic wave and receive an electromagnetic wave. When the antenna 420 is a transmit/receive-separated antenna, the antenna 420 includes a transmitting radiation portion and a receiving radiation portion. The transmitting radiation portion is used to transmit an electromagnetic wave, and the receiving radiation portion is used to receive an electromagnetic wave.

For example, the antenna 420 may be, for example, a waveguide antenna, a PCB antenna, a flexible circuit board (FPC) antenna, a slot antenna, or a patch antenna, may be an omnidirectional antenna or a directional antenna, and may be an ultra-long wave antenna, a long wave antenna, a medium wave antenna, a short wave antenna, an ultra-short wave antenna, a microwave antenna, a decimeter wave, a centimeter wave, or a millimeter-wave. This is not specifically limited. When the antenna 420 is used in a millimeter-wave radar, the antenna 420 may be specifically a millimeter-wave antenna. An operating frequency of a vehicle-mounted millimeter-wave radar is usually 76 GHz to 81 GHz.

### 2. Radome

In an embodiment, the radome 410 may be made of a material having a good electromagnetic wave penetration characteristic and a specific hardness. A selection is based on ensuring corrosion resistance and strength, while using a material with a low relative permittivity and loss value. In addition, an area of the radome 410 that faces the antenna and that is used for receiving an electromagnetic wave needs to be kept evenly, to provide a structural weatherproof housing for the antenna 420 while ensuring operating performance of the antenna 420, so that the antenna 420 is protected from an external adverse environment. For example, in some examples, a manufacturing material of the radome 410 may include but is not limited to alumina, quartz, nitride, microcrystalline glass, fiberglass, or resin.

In some cases, the radome 410 may be in a shape of a flat-plate cover, an arched cover, a spherical cover, a segmented cover, or the like, and may be based on an actual application scenario. For example, in the vehicle-mounted field, an installation position of a vehicle-mounted millimeter-wave radar usually does not affect aerodynamic profile of a vehicle. Therefore, the vehicle-mounted millimeter-wave radar is usually installed at a front bumper, a rear bumper, a b-pillar (a central pillar between a front door and a rear door) of the vehicle, or the like. Installation space of these positions is limited. Therefore, a flat-plate cover is usually used for a radome of the vehicle-mounted millimeter-wave radar to avoid introducing an extra profile height.

In some cases, still refer to FIG. 4. A thickness (T1 shown in the figure) of the radome 410 at the first groove 411 may be set to an integer multiple of kλ₁. k is any real number in [0.3,0.7], and λ₁ is a wavelength of a center frequency of an electromagnetic wave that is radiated by the radiation portion and that is in a dielectric corresponding to the radome. In other words, the thickness T1 of the radome 410 corresponding to the radiation direction of the radiation portion 421 may be set to an integer multiple of 0.3 to 0.7 times a dielectric wavelength of the radome corresponding to the center frequency. It can be learned from the introduction of the term explanations that an integer multiple of 0.5 times a dielectric wavelength of the radome is an optimal thickness of the radome, and the integer multiple of 0.3 to 0.7 times a dielectric wavelength is close to the integer multiple of 0.5 times a dielectric wavelength. A thickness is selected from a thickness range around the optimal thickness as the thickness of the radome at the first groove, so that radiation performance of the antenna can be ensured while the thickness of the radome is reduced, minimizing interference of the radome on an electromagnetic wave radiated by the antenna.

Further, in some cases, to ensure optimal radiation performance, the thickness T1 of the radome 410 at the first groove 411 may alternatively be set to the optimal thickness of the radome, that is, an integer multiple of half of a dielectric wavelength, to minimize reflection impact of the radome on an incident electromagnetic wave, and reduce interference of the radome on an electromagnetic wave radiated by the antenna.

It may be understood that, a greater thickness T1 of the radome 410 at the first groove 411 indicates greater structural strength of the radome 410 and a greater loss of transmitting an electromagnetic wave. Therefore, a middle ground needs to be found based on the structural strength of the radome 410 and the transmission loss of the electromagnetic wave. In some cases, in this application, through experimental tests, the thickness T1 of the radome 410 at the first groove 411 may be set to two dielectric half-wavelengths of the radome corresponding to the center frequency, that is, the dielectric wavelength of the radome corresponding to the center frequency. The thickness can ensure both good structural strength and antenna gain of the radome 410.

In some cases, still refer to FIG. 4, a depth (T2 in the figure) of the first groove 411 may be set to an integer multiple of mλ₂. m is any real number greater than 0.1, and λ₂ is a free-space wavelength corresponding to the center frequency of the electromagnetic wave radiated by the radiation portion. In other words, the thickness T2 of the air gap along the radiation direction of the radiation portion 421 may be set to an integer multiple of any real number, greater than 0.1, times the free-space wavelength corresponding to the center frequency. If actual installation space is small, the thickness T2 may be set to an integer multiple of 0.1 or a value close to 0.1 times the free-space wavelength. If actual installation space is large, the thickness T2 may be set to an integer multiple of a slightly larger free-space wavelength. For example, it is found through simulation that, when the thickness T2 is set to an integer multiple of 0.25 or a value close to 0.25 times the free-space wavelength, an air gap with the thickness is small and helps reduce an energy loss of an electromagnetic wave transmitted in free space. This helps further reduce the thickness of the radome and improve radiation efficiency of the antenna.

Further, in some cases, it is considered that both the thickness T1 of the radome 410 at the first groove 411 and the depth T2 of the first groove 411 are related to the center frequency of the electromagnetic wave. Therefore, the thickness T1 of the radome 410 at the first groove 411 and the depth T2 of the first groove 411 may be adjusted, so that the radome 410 can be better applicable to different operating frequency bands. For example, for any application scenario, an operating frequency band in which the radiation portion 421 radiates an electromagnetic wave in the current application scenario may be first determined, and a frequency at a center of the operating frequency band is used as a center frequency of the electromagnetic wave. Next, a dielectric material for making the radome 410 is determined, and a dielectric wavelength corresponding to the dielectric material at the center frequency of the electromagnetic wave is obtained by calculating a correspondence between a frequency and a wavelength that correspond to the dielectric material. Then, the thickness T1 of the radome 410 at the first groove 411 may be an integer multiple of 0.3 to 0.7 times the dielectric wavelength. In addition, a correspondence between a frequency and a wavelength that correspond to a vacuum environment may be further calculated, to obtain a corresponding free-space wavelength at the center frequency of the electromagnetic wave, and then the depth T2 of the first groove 411 may be an integer multiple of a value greater than 0.1 times the free-space wavelength. For example, the thickness T1 of the radome 410 at the first groove 411 may be an integer multiple of 0.5 times the dielectric wavelength of the radome, and the depth T2 of the first groove 411 may be an integer multiple of 0.25 times the free-space wavelength. In this way, the thickness T1 of the radome 410 at the first groove 411 is set to an optimal thickness of the radome 410 applicable to electromagnetic wave transmission in the current application scenario, and the depth T2 of the first groove 411 is set to an appropriate depth for the air gap applicable to the electromagnetic wave transmission in the current application scenario, so that the radome 410 can better adapt to the antenna 420 in the current application scenario.

The thickness T1 of the radome 410 at the first groove 411 is set to the integer multiple of 0.3 to 0.7 times the dielectric wavelength of the radome, or the depth T2 of the first groove 411 is set to the integer multiple of a value greater than 0.1 times the free-space wavelength, for example. During actual operation, the thickness T1 of the radome 410 at the first groove 411 or the depth T2 of the first groove 411 may alternatively be set to another value, and does not need to be limited to the foregoing thickness. For example, in an example, the thickness T1 of the radome 410 at the first groove 411 may alternatively be set to an integer multiple of the dielectric wavelength of the radome corresponding to the center frequency, and the depth T2 of the first groove 411 is set to an integer multiple of a value less than or equal to 0.1 times the free-space wavelength. In this way, radiation effect can also be achieved to some extent.

In an embodiment, in consideration of arrangement of the first groove 411 in the radome 410 weakens structural strength of the radome 410 at the first groove 411, a supporting structure may be further disposed to support the area with weak structural strength. For example, FIG. 7 is an example of a diagram of another antenna structure according to this application. Refer to FIG. 7 and FIG. 4. In this example, a support portion 430 is disposed in the first cavity, and the support portion 430 is connected between the first surface S₂₁ of the antenna 420 and the radome 410, and is staggered with respective to the radiation portion 421. For example, the support portion 430 may be staggered with respective to the radiation port (or further including the choke groove) in the radiation portion 421. For example, the support portion 430 may be disposed at any position in the first groove 411 except an area directly facing the radiation port (or further including the choke groove). One end of the support portion 430 is fastened to an inner wall surface of the first groove 411, and the other end of the support portion 430 is topped on an outer surface of the antenna 420, to support the weak radome 410 at the first groove 411, thereby effectively improving structural strength of the radome 410 at the first groove 411 and improving a protection capability of the radome 410.

In some cases, the support portion 430 and the inner wall surface of the first groove 411 may be fastened together in a plurality of manners. For example, in an example, the support portion 430 may be disposed separately from the radome 410, and one end of the support portion 430 is fastened to the inner wall surface of the first groove 411 in the radome 410 by pasting, welding, bolting, clamping, riveting, magnetic suction, and the like. Alternatively, in another example, the support portion 430 and the radome 410 may be integrally formed. For example, a position of the first groove 411 provided in the radome 410 and a position of the support portion 430 that is staggered with respective to the radiation port are based on a position of the radiation port of the antenna 420 that is used together. A mold uses these positions as reference. The fastened support portion 430 and radome 410 are obtained through one fabrication by filling the mold with a casting material. Fabrication processes of the radome 410 and the support portion 430 can be simplified by using the integrally formed structure design.

Further, in some cases, the support portion 430 and the radome 410 may be made of a same material. For example, in an integrated molding structure design, the fastened support portion 430 and radome 410 may be directly obtained by casting with a same material, thereby reducing a fabrication difficulty.

Further, in some cases, the support portion 430 may be made of a wave-absorbing material. The wave-absorbing material is a type of material that can absorb or greatly reduce electromagnetic wave energy received on a surface of the wave-absorbing material, to reduce electromagnetic wave interference. Therefore, the support portion 430 is fabricated by using the wave-absorbing material, so that an electromagnetic wave of the antenna can be suppressed to some extent, further reducing electromagnetic wave interference of the current radiation port on another radiation port.

The support portion 430 may be an independent structure. For example, the support portion 430 exists independent of the radome 410 and the antenna 420, and may be fastened to the inner wall surface of the radome 410 by pasting or snap-fit engagement, to form an integrated structure with the radome 410. Alternatively, the support portion 430 may belong to the radome 410. For example, the radome 410 with the support portion 430 may be directly fabricated through one casting, to save a process of fastening the support portion 430 to the radome 410.

Further, in some cases, still refer to FIG. 7. The support portion 430 may include one or more protrusions, and a depth of the protrusions is the same as the depth of the first groove 411. The protrusions are arranged in a regular or irregular layout, and positions of the protrusions are staggered with respective to the radiation port. For example, as shown in FIG. 7, if one first groove 411 is provided for a plurality of radiation ports, the support portion 430 may include a plurality of protrusions, and the plurality of protrusions are staggered with respective to the plurality of radiation ports. For example, when one first groove 411 is provided for all three radiation ports 4211, 4212, and 4213 of the antenna 420, two protrusions, a protrusion 431 and a protrusion 432, may be disposed in the first groove 411. The protrusion 431 is disposed between the radiation port 4211 and the radiation port 4212, and may separate electromagnetic waves radiated from the radiation port 4211 and the radiation port 4212. Similarly, the protrusion 432 is disposed between the radiation port 4212 and the radiation port 4213, and may separate electromagnetic waves radiated from the radiation port 4212 and the radiation port 4213.

Further, in some cases, the plurality of protrusions may be arranged periodically or aperiodically. In FIG. 7, periodic arrangement is used as an example. This arrangement manner may suppress transverse propagation of electromagnetic wave energy, allowing more electromagnetic wave energy to be radiated along upper half-space in the figure.

It may be understood that, still refer to FIG. 7. The first surface S₂₁ of the antenna 420 is attached to the first surface S₂₁ of the radome 410. Therefore, a height of the protrusion disposed in the first groove 411 is the same as the depth T2 of the first groove 411, and other parameters of the protrusion, such as a length and a width, may be based on a projection area of the radiation port on the first groove 411. For example, the length of the protrusion is not greater than a length of an area on the inner wall surface of the first groove 411 excluding an area that directly faces the antenna radiation port, and the width of the protrusion is not greater than a width of an area on the inner wall surface of the first groove 411 excluding an area that directly faces the antenna radiation port.

It should be understood that the protrusion in a form of a cuboid or cube is used as an example in the foregoing descriptions. A shape of the protrusion in this application may be any regular or irregular shape that can play a support function, for example, may include but is not limited to a polyhedron such as a cube or a cuboid, a cylinder, an ellipse, an ellipsoid, a sphere, a trapezoid, a cone, or an amorphous body. In addition, when there are a plurality of protrusions, and depths of the plurality of protrusions are the same as the depth of the first groove 411, shapes of the plurality of protrusions may be the same as or may be different from that of the first groove 411. A spacing between adjacent protrusions may be the same or may be different, which may be specifically determined according to a processing capability. For example, according to an existing processing capability, a minimum spacing between two protrusions is 0.2 mm. Therefore, the spacing between adjacent protrusions may be greater than or equal to 0.2 mm.

In addition, FIG. 7 illustrates an example in which one protrusion is disposed between two adjacent radiation ports. However, in an actual antenna structure, one protrusion may alternatively be spaced from a plurality of radiation ports. For example, there may be at least two radiation ports on one side of one protrusion, and there may be one radiation port on the other side of the protrusion, or there are a plurality of radiation ports on each side of one protrusion. This is not specifically limited in this application.

The foregoing antenna structure is used. The radome and the antenna are attached together, and the groove is provided at a position of the radome corresponding to the radiation portion of the antenna. This is equivalent to moving the air gap (e.g., T2 shown in FIG. 3a) between the radome and the antenna in the conventional technology to the inside of the radome for example, so as to save the air gap between the radome and the antenna, effectively reduce the thickness of the antenna structure, and allow the antenna structure to be applicable to an application scenario in which an installation height is small. In addition, the groove in the radome can further ensure that there is an air gap between the radiation portion of the antenna and the radome, to maintain radiation performance of the antenna. It can be learned that in the antenna structure shown in FIG. 4, a profile height of the antenna structure can be reduced, and radiation performance of the antenna is ensured, thereby considering both antenna performance and a miniaturization design.

The foregoing content describes an example structure of the antenna structure 400. The following provides two example application scenarios of the antenna structure 400.

### Application Scenario 1:

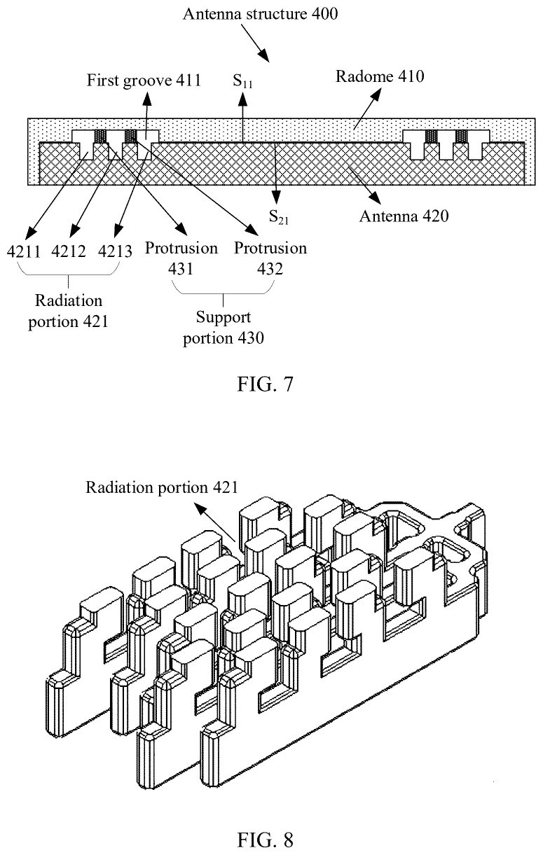

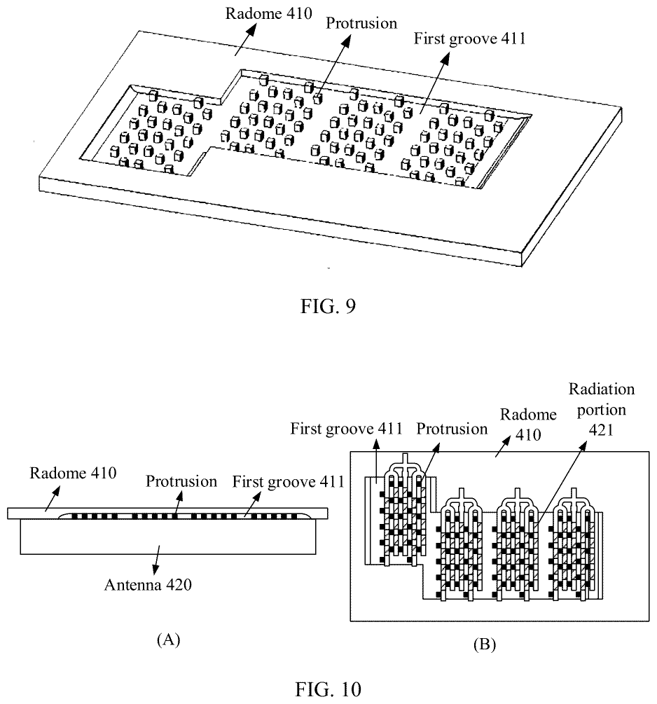

Refer to FIG. 8 to FIG. 10. FIG. 8 is a diagram of a structure of a waveguide antenna according to an application scenario 1. FIG. 9 is a diagram of a structure of a radome for the waveguide antenna in the application scenario 1 according to this application. FIG. 10 is a diagram of an antenna structure obtained by assembling the waveguide antenna in the application scenario 1 and the radome. (A) in FIG. 10 shows a cross-sectional diagram of the antenna structure from a side view, and (B) in FIG. 10 shows a cross-sectional diagram of the antenna structure from a top view.

First, refer to FIG. 9. For the waveguide antenna shown in FIG. 8, a plate-shaped radome 410 is illustrated in this application. A first groove 411 is provided in the radome 410, a plurality of discrete protrusions are disposed on an inner wall surface of the first groove 411, and the plurality of discrete protrusions are periodically arranged (or may be aperiodically arranged). In addition, to cover a plurality of waveguide antennas at once by using the radome 410, the first groove 411 may be with a large size, and protrusions corresponding to the plurality of waveguide antennas may be disposed in parallel inside the first groove 411. For example, in the figure, the radome 410 covers four waveguide antennas, three of the four waveguide antennas are disposed in parallel, and a remaining waveguide antenna is staggered with respective to the three waveguide antennas. Moreover, to reduce impact of the radome 410 on performance of the waveguide antenna in radiating an electromagnetic wave, a thickness of the radome 410 at the first groove 411 may be set to a half of a wavelength of a center frequency of the electromagnetic wave in a dielectric corresponding to the radome. A thickness of the radome 410 at another position is greater than the thickness. A thickness difference between the thickness of the another position and the thickness of the radome 410 at the first groove 411 may be understood as a depth of the first groove 411.

Then, refer to (A) in FIG. 10. After the radome 410 and the waveguide antenna 420 are assembled together, a surface of the radome 410 and a surface of the waveguide antenna 420 that are connected to each other are directly attached together. The radome 410 and the waveguide antenna 420 are disposed without a gap between each other, and the first groove 411 is provided in an area of the radome 410 corresponding to a radiation portion 421 of the antenna. In addition, refer to (B) in FIG. 10. The radome 410 covers the four waveguide antennas at once, and an aperture of the waveguide antenna is large, so that the first groove 411 provided in the inner wall surface of the radome 410 also forms a large cavity structure. To improve structural strength of the cavity structure, the plurality of protrusions may be disposed on the inner wall surface of the first groove 411 in a direction toward the waveguide antenna. One end of each protrusion is connected to the radome 410, and the other end of each protrusion is connected to the waveguide antenna. In addition, the protrusions are arranged periodically (or aperiodically), and positions of the protrusions are staggered with respective to the radiation portion 421 of the waveguide antenna.

In the application scenario 1, the waveguide antenna has advantages such as high power, enhanced shielding, and low loss, but also has a high profile height. The radome may be attached to the waveguide antenna, and the groove is provided at a position of the radome corresponding to the radiation portion of the waveguide antenna. In this way, a thickness of an antenna structure obtained by assembling the radome onto the waveguide antenna can be minimized, and an impact on radiation performance of the waveguide antenna can be minimized after the radome and the waveguide antenna are assembled. This helps reduce a profile height of the antenna structure and maintain radiation performance of the antenna, so that the antenna structure is adapted to a scenario with small installation space.

### Application Scenario 2:

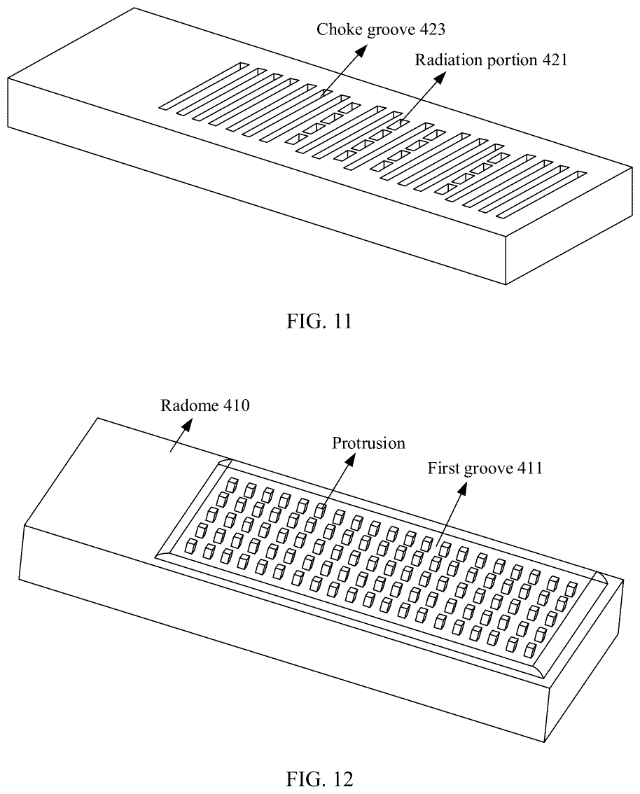

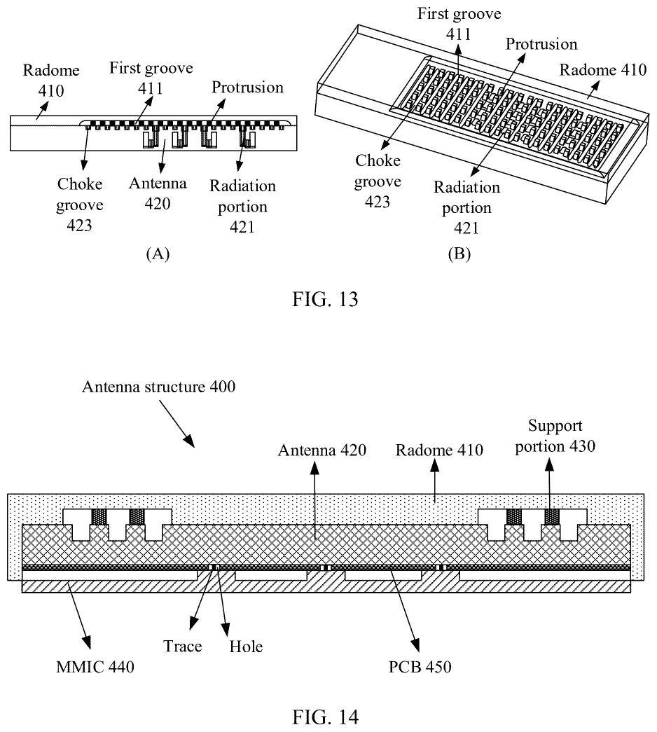

Refer to FIG. 11 to FIG. 13. FIG. 11 is a diagram of a structure of a waveguide antenna according to an application scenario 2. FIG. 12 is a diagram of a structure of a radome for the waveguide antenna in the application scenario 2 according to this application. FIG. 13 is a diagram of an antenna structure obtained by assembling the waveguide antenna in the application scenario 2 and the radome. (A) in FIG. 13 shows a cross-sectional diagram of the antenna structure from a side view, and (B) in FIG. 13 shows a top view of the antenna structure. It should be noted that, for ease of describing the solution more clearly, (B) in FIG. 13 shows an internal assembly structure in a perspective manner (the radome 410 may be considered as a transparent structure).

First, refer to FIG. 11. For the waveguide antenna in the application scenario 2, in addition to a radiation portion 421, a choke groove 423 is further provided in an antenna body. The choke groove 423 is provided in parallel with the radiation portion 421, and may be configured to suppress an electromagnetic wave propagating through a surface of the choke groove, to prevent an electromagnetic wave radiated by the radiation portion 421 from being propagated in a transverse direction shown in the figure, thereby avoiding electromagnetic wave interference between radiation ports of different columns.

Second, refer to FIG. 12. For the waveguide antenna shown in FIG. 11, a cuboid-shaped radome 410 is illustrated in this application. A first groove 411 is provided in the radome 410, a plurality of protrusions are disposed on an inner wall surface of the first groove 411, and the plurality of protrusions are periodically arranged (or may be aperiodically arranged). Because the waveguide antenna shown in FIG. 11 occupies large space, the radome shown in FIG. 12 may be used to cover a waveguide antenna, and the plurality of protrusions disposed in the first groove 411 of the radome are staggered with respective to the choke groove 423 and the radiation portion 421 that are parallel in the waveguide antenna. For example, positions of the plurality of protrusions may be disposed between any adjacent choke grooves 423, or between any adjacent radiation portions 421, or between any adjacent choke groove 423 and the radiation portion 421, to implement a normal radiation function of the radiation portion 421, and prevent impact on a normal function of the choke groove 423 for suppressing a surface electromagnetic wave. Moreover, to reduce impact of the radome 410 on performance of the waveguide antenna in radiating an electromagnetic wave, a thickness of the radome 410 at the first groove 411 may be set to a half of a wavelength of a center frequency of the electromagnetic wave in a dielectric corresponding to the radome. A thickness of the radome 410 at another position is greater than the thickness. A thickness difference between the thickness of the another position and the thickness of the radome 410 at the first groove 411 may be a depth of the first groove 411.

Further, refer to (A) in FIG. 13. After the radome and the waveguide antenna are assembled together, a surface of the radome 410 and a surface of the waveguide antenna 420 that are connected to each other are directly attached together. The radome 410 and the waveguide antenna 420 are disposed without a gap between each other, and the first groove 411 is provided in an area of the radome 410 corresponding to the radiation portion 421 and the choke groove 423. Because the radiation portion 421 and the choke groove 423 that are disposed in parallel occupy a large area, the first groove 411 is large, and a large cavity structure is formed. Refer to (B) in FIG. 13. To improve structural strength of the cavity structure, the plurality of protrusions may be disposed on the inner wall surface of the first groove 411 in a direction toward the waveguide antenna. One end of each protrusion is connected to the radome 410, and the other end of each protrusion is connected to the waveguide antenna 420. In addition, the protrusions are arranged periodically (or aperiodically), and positions of the protrusions are staggered with respective to the radiation portion 421 and the choke groove 423 of the waveguide antenna 420.

In the application scenario 2, the waveguide antenna has both the radiation port and the choke groove. The radome may be attached to the waveguide antenna, and the groove is provided at a position of the radome corresponding to the radiation port and the choke groove of the waveguide antenna. In this way, a thickness of an antenna structure obtained by assembling the radome onto the waveguide antenna can be minimized, an impact on radiation performance of the waveguide antenna can be minimized after the radome and the waveguide antenna are assembled, and a function of the choke groove in suppressing a surface electromagnetic wave is supported by avoiding the choke groove. This helps reduce a profile height of the antenna structure and maintain radiation performance and an anti-interference capability of the antenna, so that the antenna structure is adapted to a scenario with small installation space.

Based on the antenna structure shown in FIG. 7, FIG. 14 is a diagram of still another antenna structure according to this application. As shown in FIG. 14, in addition to the foregoing radome 410, antenna 420, and support portion 430, the antenna structure 400 may further include a monolithic microwave integrated circuit (MMIC) 440. The MMIC 440 is coupled to the antenna 420, and is configured to: send a frequency-modulated signal (an electromagnetic wave) to the antenna 420, or receive an echo signal from the antenna 420, and perform target detection based on the echo signal.

In some cases, the MMIC 440 may be understood as a chip having a processing capability, and may include one or more processing units. The processing unit is a circuit having a signal (or data) processing capability. For example, the processing unit may be a circuit having a capability of reading and running instructions, for example, a central processing unit (CPU), a microprocessor, a graphics processing unit (GPU) (may be understood as a microprocessor), or a digital signal processor (DSP). In another example, the processing unit may implement a specific function by using a logical relationship of a hardware circuit. The logical relationship of the hardware circuit is fixed or reconfigurable. For example, the processor is a hardware circuit implemented by using an application-specific integrated circuit (ASIC) or a programmable logic device (PLD), for example, a field programmable gate array (FPGA). In a reconfigurable hardware circuit, a process in which the processing unit loads a configuration document to implement configuration of the hardware circuit may be understood as a process in which the processing unit loads instructions to implement functions of some or all of the foregoing units. In addition, the processing unit may alternatively be a hardware circuit for artificial intelligence, and may be understood as an ASIC, for example, a neural network processing unit (NPU), a tensor processing unit (TPU), or a deep learning processing unit (DPU). For example, the processing unit may alternatively be an application processor (AP), an image signal processor (ISP), another programmable logic device, a transistor logic device, a hardware component, or any combination thereof. Different processing units may be independent components, or may be integrated into one or more processors.

In an embodiment, still refer to FIG. 14. The antenna structure 400 may further include a PCB 450. The PCB 450 is disposed between the antenna 420 and the MMIC 440, a hole is provided in the PCB 450, a trace is disposed in the hole, and the MMIC 440 and the antenna 420 are communicatively connected by using the trace in the hole. As such, the PCB may support the antenna and the MMIC, as well as to separate the antenna from the MMIC, thereby reducing crosstalk between the antenna and the MMIC.

It may be understood that the PCB 450 may alternatively be replaced with any other type of circuit board, for example, an FPC, a ceramic circuit board, an aluminum substrate, a high frequency board, a thick copper board, or an impedance board. This is not specifically limited.

It may be understood that the antenna structure shown in FIG. 14 is merely an example. The antenna structure may further include more, fewer, or different structures, and each structure may include more, fewer, or different components. These components may be combined or divided in any manner. This is not specifically limited in this application.

The antenna structure is described in the foregoing content. The following describes a detection apparatus equipped with the antenna structure.

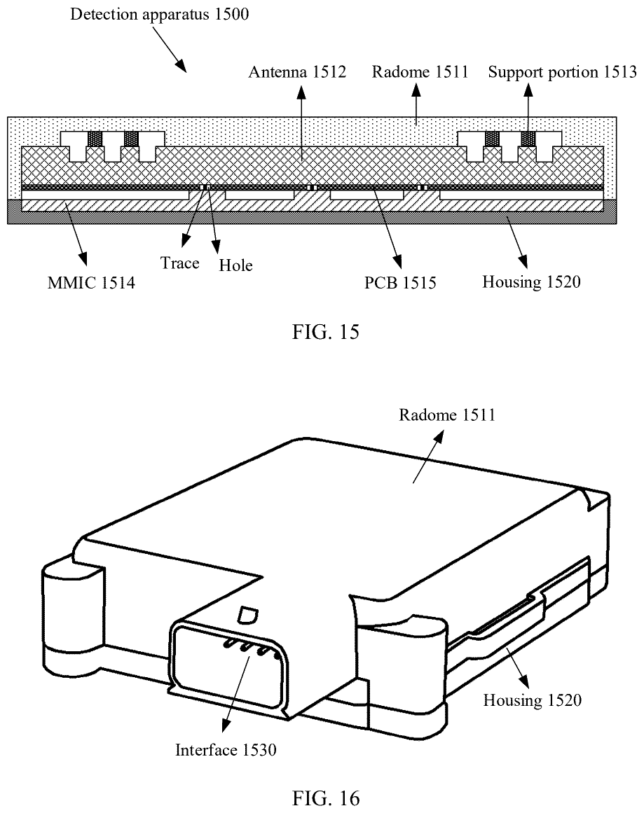

FIG. 15 is a diagram of an example structure of a detection apparatus according to this application. The detection apparatus 1500 may include an antenna structure. The antenna structure may be any one of the foregoing antenna structures, for example, the antenna structure described in any one of the embodiments in FIG. 4 to FIG. 14. FIG. 15 shows an example in which the antenna structure shown in FIG. 14 is included. The antenna structure includes a radome 1511 and an antenna 1512 that is in contact with the radome 1511. A groove is provided in an area of the radome 1511 relative to a radiation portion of the antenna 1512, and a support portion 1513 is disposed in the groove and connected between a groove bottom and the antenna. According to the foregoing analysis, in this structure design, a profile height of the antenna structure can be reduced and structural strength of the radome can be maintained. Therefore, the detection apparatus equipped with the antenna structure can have a small height and good structural strength, so that the detection apparatus can be adapted to an application scenario with small installation space.

In an embodiment, still refer to FIG. 15. The detection apparatus 1500 may further include a housing 1520. The housing 1520 and the radome 1511 are assembled together to form a cavity structure, and the antenna 1512 is built in the cavity structure. In some cases, the housing 1520 is usually a metal housing, and a position at which the housing 1520 and the radome 1511 are assembled may be sealed, so that a sealed cavity is formed between the housing 1520 and the radome 1511. The antenna 1512, the PCB 1515, and the MMIC 1514 are all built in the sealed cavity. In this way, the housing and the radome may be used as protection devices of the detection apparatus, to protect the antenna, the PCB, the MMIC, and the like disposed inside the protection device.

For example, FIG. 16 is an appearance diagram of a detection apparatus according to this application. Refer to FIG. 15 and FIG. 16. In the detection apparatus 1500, the radome 1511 and the housing 1520 form a main structure of the detection apparatus 1500, or are referred to as enclosures of the detection apparatus 1500. The antenna 1512, the PCB 1515, and the MMIC 1514 that are placed inside the radome 1511 and the housing 1520 are packaged, to prevent these devices from being affected by external environment interference.

Further, for example, still refer to FIG. 16. The detection apparatus 1500 may further include an interface 1530. One end of the interface 1530 inside the cavity is connected to the MMIC 1514 shown in FIG. 15, and one end of the interface 1530 outside the cavity is connected to a peripheral circuit. The interface 1530 is configured to transmit a signal between the MMIC 1514 and the peripheral circuit, to implement a detection function of the detection apparatus 1500. For example, when the detection apparatus 1500 is inserted into a vehicle-mounted controller through the interface 1530, the detection apparatus 1500 may receive a control instruction from the vehicle-mounted controller, and may control, according to the control instruction, the antenna 1512 to transmit an electromagnetic wave of a corresponding band, and may further receive an echo signal reflected by a target, obtain information about the target after processing the echo signal, and send the information to the vehicle-mounted controller through the interface 1530. In this way, the vehicle-mounted controller determines a next driving manner according to the information about the target, for example, how to avoid an obstacle.

For example, the detection apparatus 1500 may be a radar, for example, may include but is not limited to a millimeter-wave radar, a microwave radar, an ultra-short wave radar, a continuous wave radar, or a pulse radar, and may be configured to implement a coverage function in a plurality of scenarios such as a long range, a medium range, and a short range. Alternatively, the detection apparatus 1500 may be a communicator, for example, may include but is not limited to a vehicle-mounted antenna communicator, a television antenna communicator, a remote sensing antenna communicator, or a mobile phone antenna communicator. Alternatively, the detection apparatus 1500 may be any other apparatus including an antenna and a radome, which is not specifically limited.

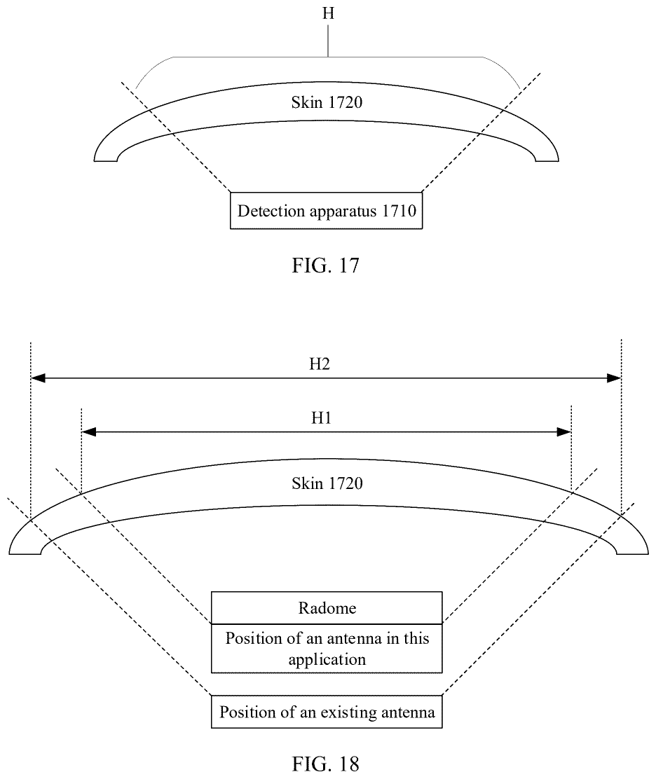

Based on the foregoing described structure of the detection apparatus, this application may further provide a terminal device. FIG. 17 is a diagram of an example structure of a terminal device according to this application. The terminal device may include a detection apparatus 1710, and the detection apparatus may be the detection apparatus in any one of the foregoing embodiments, for example, the detection apparatus 1500 shown in FIG. 15 or FIG. 16.

In an embodiment, still refer to FIG. 17. The terminal device may further include a skin 1720. The skin 1720 is disposed on an outer side of the detection apparatus 1710, and is configured to maintain an aerodynamic profile of the terminal device. The skin may be understood as an outermost layer of skin enclosing the terminal device, for example, an outermost layer of skin enclosing a vehicle framework, an aircraft framework, a ship framework, or the like. The skin is usually a metal housing with a high bearing capacity and rigidity, and has a light weight, serving to bear and transmit aerodynamic loads.

The structure features (such as the thickness, smoothness, and the like) of the skin 1720 at a position corresponding to an electromagnetic wave radiation area is determined to avoid impact of the skin 1720 on an electromagnetic wave radiated by the detection apparatus 1710. For example, an area H shown in FIG. 17 is an area that the electromagnetic wave passes through in an operating process of the detection apparatus 1710, and a thickness of the area H is based on the transmitted electromagnetic wave, to avoid excessively strong interference to the electromagnetic wave. Smaller coverage of the area H indicates fewer areas with a special structural design on the skin 1720 and a higher degree of structure freedom of the skin 1720. On the contrary, larger coverage of the H area indicates larger areas with a special structural design on the skin 1720 and a lower degree of structure freedom of the skin 1720. Therefore, to improve a degree of structure freedom of the skin 1720 and reduce a design difficulty of the skin 1720, how to reduce the coverage of the area H needs to be considered.

In some cases, FIG. 18 is a comparison diagram of a skin design between a detection apparatus provided in this application and an existing detection apparatus. For ease of description, an antenna structure in the detection apparatus is shown in the figure, and the antenna structure is simply divided into an antenna and a radome, and other structures in the detection apparatus are not shown. In addition, it is assumed in the figure that a radome in the detection apparatus in this application and a radome in the existing detection apparatus are in a same position. As shown in FIG. 18, when divergence angles of electromagnetic waves radiated by antennas are consistent, the antenna and the radome in an antenna structure in this application are attached together, and an electromagnetic wave emitted by the antenna, after being transmitted through the radome intersects with the skin 1720, for example, at an area H1. In an existing antenna structure, there is an air gap between the antenna and the radome. An electromagnetic wave emitted by the antenna, after being transmitted through the air gap and the radome intersects with the skin 1720, for example, at an area H2. The area H2 is obviously greater than the area H1. It can be learned that, compared with the existing antenna structure, in the antenna structure in this application, the overlapping area between the electromagnetic wave radiated by the antenna and the skin 1720 is smaller. This provides greater structural freedom for manufacturing and installation of the skin 1720.

It should be noted that the structure of the terminal device shown in FIG. 17 is merely an example. In another example, the terminal device may include more, fewer, or different structures, and each structure may include more, fewer, or different components. For example, in some examples, the terminal device may further include a controller. The controller is connected to the detection apparatus, and is configured to control the detection apparatus to implement a detection function. For another example, in some other examples, the terminal device may further include a memory. The memory is configured to store a program or data, such as data of a target detected by the detection apparatus, so that another device can access the programs or data. For another example, in other examples, the terminal device may further include a transceiver, and the transceiver is configured to communicate with an external device. In addition, the shown components or components that are not shown may be combined or divided in any manner. This is not specifically limited in this application.

For example, the terminal device may be a transportation means (e.g., a car, a truck, a motorcycle, a bus, a ship, an airplane, a helicopter, a recreational vehicle, an amusement park vehicle, a construction vehicle, an electric vehicle, a golf cart, a train, an unmanned vehicle, a smart vehicle, or a digital vehicle), a robot, a surveying and mapping device, a smart home device (e.g., a television, a robot vacuum cleaner, a smart desk lamp, a sound system, a smart lighting system, an electric appliance control system, home background music, a home theater system, an intercom system, or video surveillance), a smart manufacturing device (e.g., an industrial device or a lawn mower), a smart transportation device (e.g., an AGV, an unmanned transport vehicle, or a lorry), or a smart terminal (e.g., a mobile phone, a computer, a tablet computer, a palmtop computer, a desktop computer, a headset, a sound box, a wearable device, a vehicle-mounted device, a virtual reality device, or an augmented reality device).

In this application, “at least one” means one or more, and “a plurality of” means two or more. The term “and/or” describes an association relationship between associated objects, and represents that three relationships may exist. For example, A and/or B may represent the following cases: Only A exists, both A and B exist, and only B exists, where A and B may be singular or plural. “At least one of the following items (pieces)” or a similar expression thereof means any combination of these items, including any combination of singular items (pieces) or plural items (pieces). For example, at least one item (piece) of a, b, or c may indicate a, b, c, “a and b”, “a and c”, “b and c”, or “a, b, and c”, where a, b, and c may be singular or plural. In the text descriptions of this application, the character “/” generally indicates an “or” relationship between the associated objects. In the formula of this application, the character “/” indicates a “division” relationship between the associated objects. In addition, in this application, the word “example” is used to represent giving an example, an illustration, or a description. Any embodiment or design scheme described as an “example” in this application should not be explained as being more preferred or having more advantages than another embodiment or design scheme. Alternatively, it may be understood as that the word “example” is used to present a concept in a specific manner, and does not constitute a limitation on this application.

It may be understood that various numbers in this application are merely used for differentiation for ease of description, and are not used to limit the scope of embodiments of this application. Sequence numbers of the foregoing processes do not mean a sequence of execution. The sequence of execution of the processes should be determined according to functions and internal logic of the processes. The terms “first”, “second” and the like are intended to distinguish between similar objects, but do not necessarily indicate a specific order or sequence. In addition, the terms “include”, “have”, and any variant thereof are intended to cover non-exclusive inclusion, for example, include a series of steps or units. A method, system, product, or device is not necessarily limited to those steps or units expressly listed, but may include other steps or units not expressly listed or inherent to such a process, method, product, or device.

1. An antenna structure, comprising:
a radome having a first radome surface, wherein the first radome surface includes a first grove; and
an antenna having a first antenna surface in contact with the first radome surface, wherein
the first antenna surface includes a radiation portion, and the first groove and the radiation portion form a first cavity.

2. The antenna structure according to claim 1, wherein a size of a groove opening of the first groove is greater than or equal to a size of the radiation portion.

3. The antenna structure according to claim 2, wherein the size of the groove opening of the first groove is designed based on a divergence angle of an electromagnetic wave radiated by the radiation portion.

4. The antenna structure according to claim 1, wherein the radiation portion comprises at least one radiation port.

5. The antenna structure according to claim 4, wherein the radiation portion further comprises a choke groove.

6. The antenna structure according to claim 1, wherein at least two radiation portions are provided on the first antenna surface, and a connection portion between the at least two radiation portions is in contact with the first radome surface.

7. The antenna structure according to claim 1, wherein the first antenna surface further comprises a non-radiation portion, and the non-radiation portion is in contact with the first radome surface of the radome.

8. The antenna structure according to claim 1, wherein the radiation portion comprises a transmitting radiation portion and a receiving radiation portion.

9. The antenna structure according to claim 1, wherein a support portion is disposed in the first cavity, and the support portion is connected between the first antenna surface and the radome, and is staggered with respective to the radiation portion.

10. The antenna structure according to claim 9, wherein the support portion comprises a plurality of protrusions.

11. The antenna structure according to claim 10, wherein the plurality of protrusions are arranged periodically or aperiodically.

12. The antenna structure according to claim 9, wherein the support portion is made of a wave-absorbing material, or is made of a material same as that of the radome.

13. The antenna structure according to claim 9, wherein the support portion and the radome are integrally formed.

14. The antenna structure according to claim 1, wherein a thickness of the radome at the first groove is an integer multiple of kλ₁, k is any real number in [0.3,0.7], and λ₁ is a wavelength of a center frequency of a electromagnetic wave radiated by the radiation portion and that is in a dielectric corresponding to the radome.

15. The antenna structure according to claim 1, wherein the antenna structure further comprises a monolithic microwave integrated circuit MMIC, and the MMIC is coupled to the antenna, and is configured to: send a frequency-modulated signal to the antenna, or receive an echo signal from the antenna, and perform target detection based on the echo signal.

16. The antenna structure according to claim 15, wherein the antenna structure further comprises a printed circuit board PCB, the PCB is disposed between the antenna and the MIC, a hole is provided in the PCB, a trace is disposed in the hole, and the MMIC is connected to the antenna through the trace.

17. The antenna structure according to claim 1, wherein the antenna is a waveguide antenna.

18. A detection apparatus, comprising:
an antenna structure comprising a radome and an antenna, wherein;
a first surface of the radome is in contact with a first surface of the antenna, a radiation portion is provided on the first surface of the antenna, a first groove is provided in the first surface of the radome, and the first groove and the radiation portion form a first cavity.

19. The detection apparatus according to claim 18, further comprising a housing, wherein the housing is connected to the radome to form a cavity, and the antenna is built in the cavity.

20. A terminal device, comprising:
a skin disposed on an outer side of a detection apparatus; and
the detection apparatus including an antenna structure having a radome and an antennae, wherein:
a first surface of the radome is in contact with a first surface of the antenna, a radiation portion is provided on the first surface of the antenna, a first groove is provided in the first surface of the radome, and the first groove and the radiation portion form a first cavity.
